(19) United States
(12) Patent Application Publication
(10) Pub. No.: US 2010/0156986 A1
(43) Pub. Date: Jun. 24, 2010

(54) INK JET PRINTING APPARATUS

(75) Inventor: Katsuya Tao, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/638,481

(22) Filed: Dec. 15, 2009

(30) Foreign Application Priority Data
Dec. 18, 2008 (JP) 2008-322393

(51) Int. Cl. B41J 29/377

(52) U.S. Cl. 347/18

(57) ABSTRACT

The present invention is to provide an inkjet printing apparatus configured to improve throughput by promoting fixation of ink on a print medium and to effectively promote cooling of a heating member using a relatively simple configuration. To achieve this, the present invention utilizes vaporization heat generated when vaporization components contained in ink ejected to the print medium are vaporized, to take heat from a metal member coming into contact with the print medium. The metal member is then used to cool the print head.

### BACKGROUND OF THE INVENTION

1. Field of the Invention

The present invention relates to an inkjet printing apparatus, and more specifically, to an inkjet printing apparatus comprising means for cooling a heating member provided in the inkjet printing apparatus.

2. Description of the Related Art

In recent years, the prevalence of high-resolution digital cameras have led to the need for an inkjet printing apparatus offering a high definition and a high print duty and enabling consecutive printing. Here, the print duty refers to the ratio of the actual amount of ink applied to a unit print area, to the maximum amount of ink applied to the unit print area. Ink ejection methods for an inkjet print head configured to print print media such as paper use an electrostatic force, modified piezo elements, and bubbling energy resulting from heating of ink.

In a print head based on a thermal inkjet scheme utilizing ink bubbling energy, because of the operational principle of the print head, when during consecutive ejection, the quantity of heat applied to the print head exceeds that of heat released from the print head, the temperature of the print head rises to change ejection conditions. An excessive rise in temperature may cause the print head to be destroyed. Thus, measures against the rise in temperature of the print head are an important technical challenge.

Even with the schemes other than the thermal inkjet, for members such as a driving circuit power amplifier which inevitably generates heat, an excessive rise in temperature may cause the member to be destroyed or result in the need for temperature control that requires the stoppage of driving.

Various measures against the temperature rise have been proposed. For example, Japanese Patent Laid-Open No. H07-047694 (1995) describes a method using an inkjet printing apparatus with a quiescent period; when the temperature of a print head exceeds a given value during operation, the print head suspends ejection to lower the temperature. Furthermore, Japanese Patent Laid-Open No. H06-255208 (1994) describes a method using an inkjet printing apparatus that uses a blast fan to promote thermal diffusion of a heating member to lower the temperature. Additionally, Japanese Patent Laid-Open No. H11-58777 (1999) describes a method using an inkjet printing apparatus configured to bring waste ink into contact with a radiator for a driving circuit power amplifier to vaporize the waste ink to reduce the amount of the waste ink and to utilize the vaporization heat from the waste ink to cool the radiator, thus allowing the size of the radiator to be reduced.

However, the inkjet printing apparatus described in Japanese Patent Laid-Open No. H07-047694 (1995) inevitably undergoes a decrease in throughput, for example, a decrease in the number of print media that can be printed per unit time. Furthermore, the inkjet printing apparatus described in Japanese Patent Laid-Open H06-255208 (1994) may increase costs owing to a newly provided fan mechanism. Additionally, the inkjet printing apparatus described in Japanese Patent Laid-Open No. H11-58777 (1999) brings the waste ink into direct contact with the radiator and may thus cause the non-vaporized components of the waste ink to be fixed without being vaporized, degrading the cooling effect.

### SUMMARY OF THE INVENTION

Thus, the present invention has been developed in view of the above-described problems. An object of the present invention is to provide an inkjet printing apparatus configured to improve throughput by promoting fixation of ink on a print medium and to effectively promote cooling of a heating member using a relatively simple configuration.

According to the present invention, an inkjet printing apparatus allowing a print head ejects ink to a print area on a print medium for printing, wherein after the print head ejects the ink to the print area on the print medium, a printed area on the print medium comes into abutting contact with a cooling member, and a heating section of the inkjet printing apparatus comes into abutting contact with the cooling member.

According to the present invention, a printing apparatus comprising: conveying device for conveying a print medium; a platen configured to support the print medium conveyed by the conveying device; a print head located opposite the platen to eject ink for printing; a heat transfer member located downstream of the platen in a conveying direction and brought into contact with a surface of the print medium being conveyed by the conveying medium which surface has not been printed by the print head; and elevating and lowering device for elevating and lowering the print head to bring the print head into selective contact with the heat transfer member.

According to the present invention, the print head ejects ink to the print area on the print medium, and the printed area on the print medium then comes into abutting contact with the cooling member. The cooling member is then brought into abutting contact with the heating section of the inkjet printing apparatus. The inkjet printing apparatus according to the present invention thus promotes the fixation of ink on the print medium to improve the throughput and effectively promotes cooling of the heating member using the relatively simple configuration.

Further features of the present invention will become apparent from the following description of exemplary embodiments (with reference to the attached drawings).

### BRIEF DESCRIPTION OF THE DRAWINGS

FIG. 1 is a perspective view of an inkjet printing apparatus to which the present embodiment is applicable;

FIG. 2 is a side view schematically showing the inkjet printing apparatus in FIG. 1;

FIG. 3 is a circuit block diagram of the ink jet printing apparatus in FIG. 1;

FIG. 4 is an enlarged view showing that a metal member and a print head come into abutting contact with each other at a position set outside a print range; and

FIG. 5 is a graph showing the relationship between a sheet surface temperature and a print duty.

### DESCRIPTION OF THE EMBODIMENTS

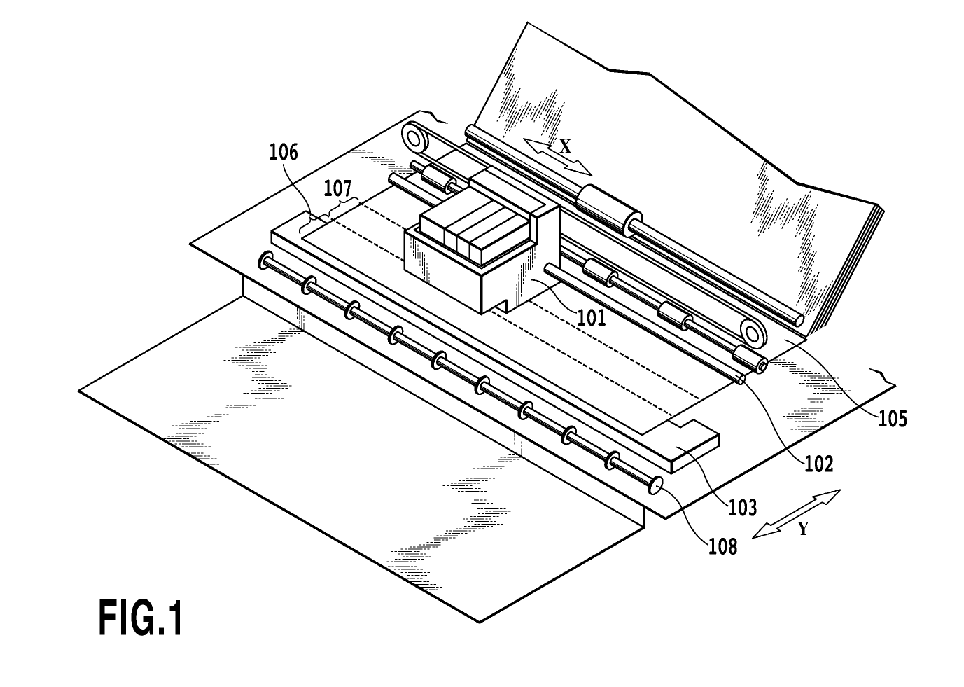

The best embodiment of the inkjet printing apparatus according to the present invention will be described with reference to the drawings. FIG. 1 is a perspective view of an inkjet printing apparatus to which the present invention is applicable. In the inkjet printing apparatus according to the present embodiment, a print head 101 ejects ink to a print medium 105 for printing. The print head 101 is attached to a guide shaft 102 so as to slide along the guide shaft 102 in a main scan direction shown by arrow X in FIG. 1.

The print medium 105 is conveyed, by a print medium conveying unit (not shown in the drawings), in a sub-scan direction shown by arrow Y in FIG. 1. The print head 101 receives a print signal from a print control section (not shown in the drawings) and ejects ink to a print area 107 on the print medium 105, while moving in the main scan direction shown by arrow X. Thus, the ink jet printing apparatus carries out printing by repeatedly allowing the print head 101 to perform a printing operation and allowing a conveying unit to conveying the print medium 105 in the sub-scan direction shown by arrow Y.

A metal member 103 is a characteristic component of the present invention. The metal member 103 is mounted on the inkjet printing apparatus to keep the print medium 105 being printed level. A printed area 106 on the print medium 105 is set between the print area 107 and a sheet discharging section 108. A part of the metal member 103 is positioned to come into contact with the back surface of the printed area 106. Vaporization components contained in ink vaporize from the printed area 106. The vaporization heat lowers the temperature of the print medium 105 and simultaneously takes heat from the metal member 103 that is in contact with the print medium 105.

In this case, if for example, the print medium 105 is curled to reduce the contact area between the print medium 105 and the metal member 103, a heat transfer efficiency decreases. Thus, electrostatic adsorption (not shown in the drawings), the sheet discharging section 108, or the like is preferably used to prevent the print medium 105 from floating to increase the contact area between the print medium 105 and the metal member 103.

When heated to an unfavorable temperature as a result of printing and the like (hereinafter simply referred to as heating), the print head 101 moves along the shaft 102 to a position set outside a print range and comes into abutting contact with the metal member 103.

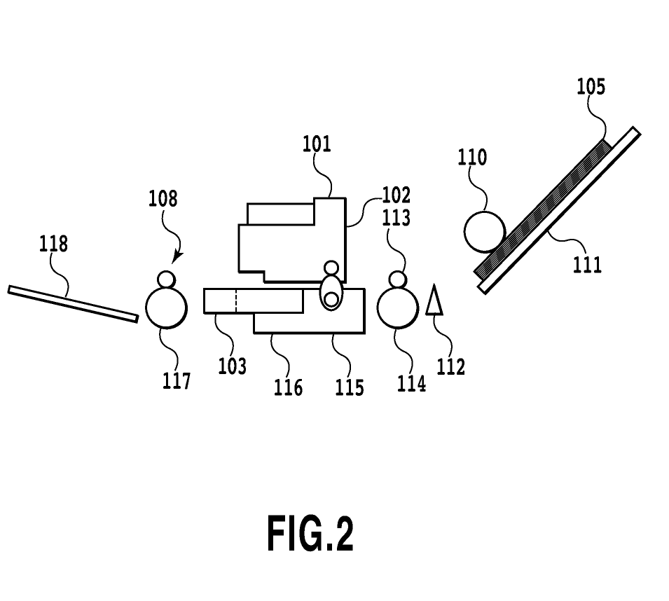

FIG. 2 is a side view schematically showing the ink jet printing apparatus in FIG. 1. The print medium 105 stacked on a sheet feeding tray 111 is fed by a sheet feeding roller 110. The fed print medium 105 is detected by a sheet sensor 112. Based on the timing of the detection, the rotation of a conveying roller 114 and a printing operation which follow the detection are controlled. After detected by the sheet sensor 114, the print medium 105 is sandwiched between the conveying roller 114 and a pinch roller 113 and conveyed to a print position by rotation of the conveying roller 114. When the print medium 105 supported by a platen 115 is conveyed to the print position, the print head 101 performs a scan at a position where the print medium 105 lies opposite the platen 115. The print medium 105 is thus printed. The print head 101 provided in the inkjet printing apparatus according to the present embodiment comprises a plurality of print elements that generate heat to allow ink to be ejected. The printed print medium 105 is further conveyed in abutment with the metal member 103 while being sandwichingly held by the sheet discharging section 108, comprising a sheet discharging roller 117.

A cam 115 rotates to allow elevation and lowering of a guide shaft 102 along which the print head 101 is guided. The guide shaft 102 elevates and lowers to allow the print head 101 and the metal member 103 to come into abutting contact with and separate from each other.

The printed print medium 105 is conveyed by the sheet discharging roller 117 and discharged onto a sheet discharging tray 118.

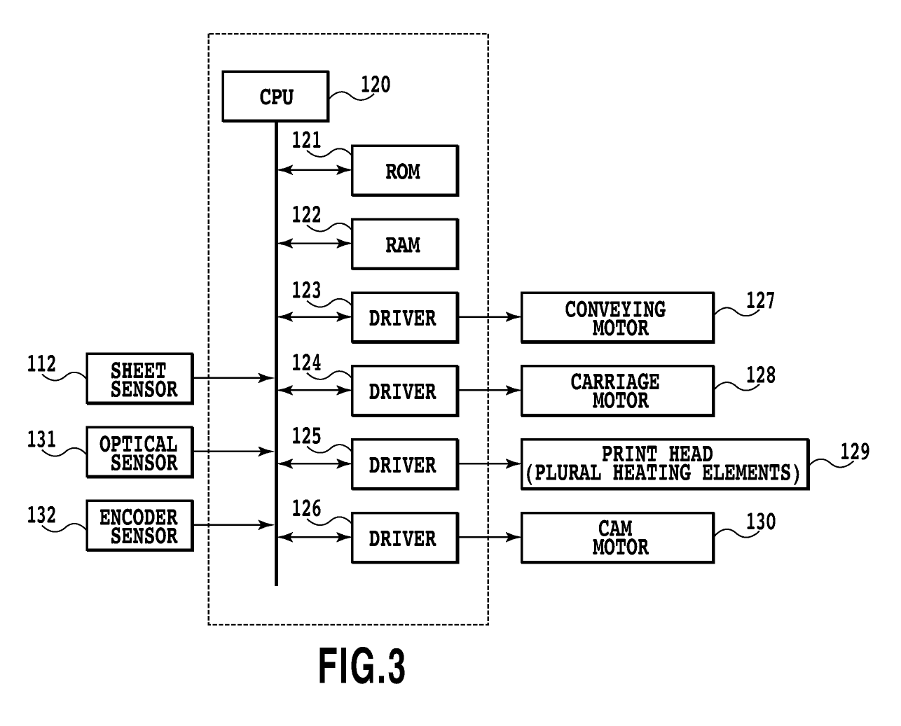

FIG. 3 is a block diagram of the inkjet printing apparatus in FIG. 1. A CPU 120 is connected to a ROM 121, a RAM 122, and various drivers (123 to 126). The ROM 121 stores programs for executing processes of controlling the operation of the inkjet printing apparatus and data processing. The RAM 122 is used as a work area in which the processes are executed. Furthermore, the various drivers (123 to 126) operate a conveying motor 127, a carriage motor 128, a print head 129, and a cam motor 130 based on information from sensors such as the sheet detecting sensor 112, an optical sensor 131, and an encoder sensor 132.

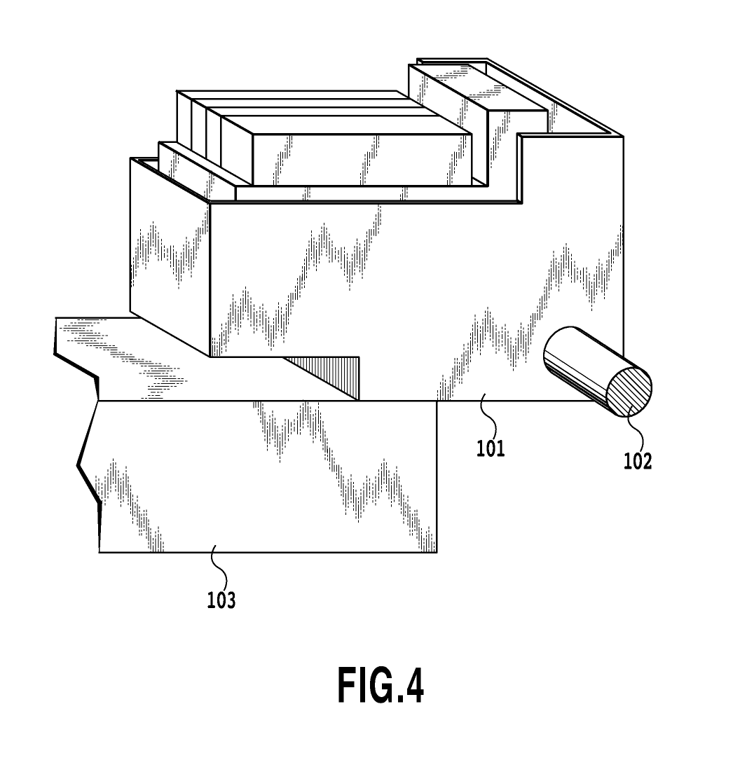

FIG. 4 is an enlarged view showing that the metal member 103 and the print head 101 come into contact with each other at the position set outside the print range of the printing apparatus of FIG. 1. When the print head 101 moves to an abutting position set outside the print range adjacent to the print area 107, the shaft 102 moves downward to bring a chip plate of the print head 101 into abutting contact with the metal member 103. At this time, the print head 101 may come into contact with a cap (not shown in the drawings) configured to perform suction recovery.

The chip plate (not shown in the drawings) of the print head 101 and the metal member 103 thus come into contact with each other to transfer heat from the print head 101 to the metal member 103. As a result, the temperature of the metal member 103 rises to promote vaporization of the ink in the printed area 106 of the print medium 105. This enables the fixation of the ink ejected to the print medium to be promoted, allowing throughput to be improved.

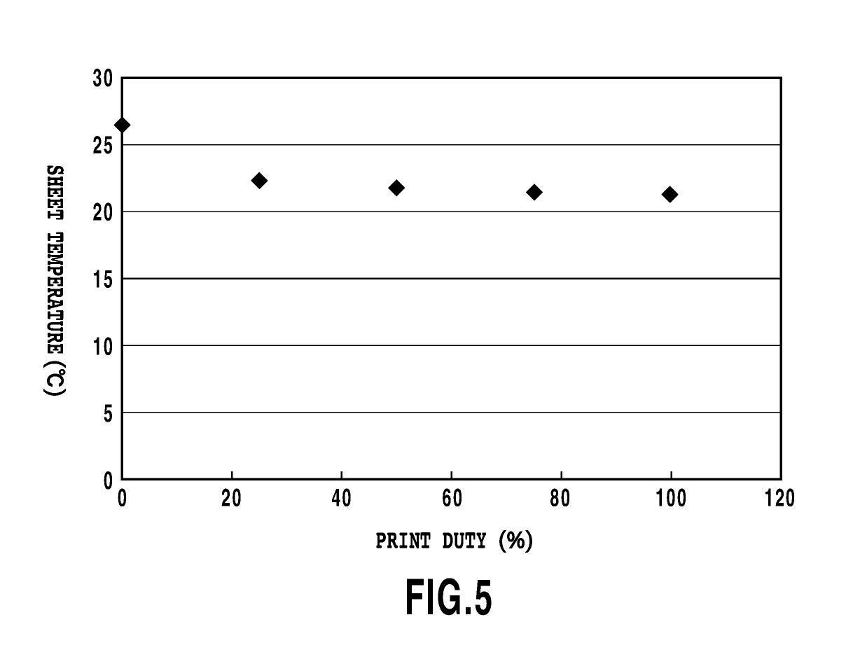

Table 1 shows the results of the present inventors' experiments intended to check the temperature of print media for each print duty (the ratio of the actual amount of ink applied to a unit print area, to the maximum amount of ink applied to the unit print area). Furthermore, FIG. 5 is a graph showing the relationship between the print medium temperature (hereinafter referred to as the sheet surface temperature) and the print duty. The results of the experiments show that a print duty of at least 25% makes the sheet surface temperature lower than the environmental temperature by about 4° C.; the environmental temperature was 26.3° C. during the experiments.

In an actual product form, when the print duty is relatively low as in the case of character printing, the total amount of ink on the print medium 105 is small, preventing a large quantity of ink vaporization heat from being obtained. In this case, however, the temperature of the inkjet printing head 101 does not rise sharply, and the effects of the present invention are not so necessary. In contrast, for photographic printing or the like which involves a relatively high print duty, the temperature of the print head 101 rises significantly, and a large total amount of ink is present on the print medium 105. This increases the quantity of vaporization heat. In this case, much heat generated by the print head 101 is transmitted to the metal member 103 to promote vaporization of the ink on the print medium. The ink can thus be effectively fixed to the print medium. Furthermore, the vaporization of the ink allows the metal member 103 to be effectively cooled. As a result, the inkjet print head 101 is effectively cooled.

In an ink jet printing apparatus with a high throughput, the reduced duration of the contact between the metal member 103 and the print medium 105 may degrade the cooling effect. In this case, the metal member 103 may be sufficiently cooled by reducing the speed of printing or sheet discharging following printing to increase the duration of the contact between the metal member 103 and the print medium 105.

Furthermore, the vaporization amount of ink measured in an environment at a temperature of 30° C. and a humidity of 80% is about 40% smaller than that measured in an environment at a temperature of 25° C. and a humidity of 55%. However, a cooling effect can be exerted even in the former environment. A sufficient effect is estimated to be exerted within the ranges of temperature and humidity for normal printing.

Test Conditions

Inkjet printing apparatus: PIXUS 990i (manufactured by Canon Inc.)
Print media: Super Photo Paper Silky A4 (manufactured by Canon Inc.)
Measurement point: point between the print area and the sheet discharging section
Print pattern: Gray-scale solid printing
Temperature measuring instrument: Radiation temperature, IT-5505 (manufactured by HORIBA, Ltd.)
Environmental temperature: 26.3° C.
Environmental humidity: 40%
Initial print medium temperature: 26.4° C.

TABLE 1

| | sheet surface | |
|---|---|---|
| duty(%) | temperature(° C.) | ΔT |
| 100 | 21.4 | −5.0 |
| 75 | 21.5 | −4.9 |
| 50 | 21.8 | −4.6 |
| 25 | 22.4 | −4.0 |

In the above-described embodiment, the heating member is the inkjet print head, which is thus cooled. However, the heating member is not limited to this. For example, a radiation fin or a driving motor (driving section) in a driving circuit may be cooled.

Furthermore, in the above-described present embodiment, the cooling member is the metal member. However, the cooling member is not limited to this aspect. The cooling member may be, for example, carbon graphite, which has a high heat conductivity.

Additionally, in the above-described present embodiment, the metal member 103, serving as the cooling member, is installed between the print area and the sheet discharging section. However, the cooling member is not limited to this aspect but may be located at any position on the side of the sheet discharging section with respect to the print area. However, since the vaporized components of ink may be attached to the inkjet print head, the metal member 103 preferably avoids being located immediately below the print area.

Furthermore, in the above-described embodiment, the cooling member comes into contact with the back surface of the print medium (the surface opposite to the print surface). However, the present invention is not limited to this aspect. For example, the cooling member may come into contact with the print surface of the print medium.

Additionally, in the present embodiment, the inkjet printing apparatus based on the scan scheme has been described. However, the inkjet printing apparatus is not limited to this aspect but may be based on, for example, a full multi scheme.

As described above, heat is taken from the metal member brought into contact with the print medium, utilizing the vaporization heat generated when the vaporization components contained in the ink ejected to the print medium are vaporized. The metal member is then used to cool the print head. The inkjet printing apparatus according to the present embodiment thus promotes the fixation of ink on the print medium to improve the throughput and effectively promotes cooling of the heating member using the relatively simple configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-322393, filed Dec. 18, 2008, which is hereby incorporated by reference herein in its entirety.

What is claimed is:

1. An inkjet printing apparatus allowing a print head ejects ink to a print area on a print medium for printing,
wherein after the print head ejects the ink to the print area on the print medium, a printed area on the print medium comes into abutting contact with a cooling member, and a heating section of the inkjet printing apparatus comes into abutting contact with the cooling member.

2. The inkjet printing apparatus according to claim 1, wherein the heating section is the print head.

3. The inkjet printing apparatus according to claim 1, wherein the heating section is at least a part of or a driving section of a driving circuit.

4. The inkjet printing apparatus according to claim 1, wherein a position on the cooling member with which the printed area on the print medium comes into contact is different from that with which the heating section of the inkjet printing apparatus comes into contact.

5. The inkjet printing apparatus according to claim 1, wherein the position of the printed area on the print medium is adjacent to the position on the cooling member with which the heating section of the inkjet printing apparatus comes into contact.

6. The inkjet printing apparatus according to claim 1, wherein the cooling member is metal.

7. A printing apparatus comprising:
conveying device for conveying a print medium;
a platen configured to support the print medium conveyed by the conveying device;
a print head located opposite the platen to eject ink for printing;
a heat transfer member located downstream of the platen in a conveying direction and brought into contact with a surface of the print medium being conveyed by the conveying medium which surface has not been printed by the print head; and
elevating and lowering device for elevating and lowering the print head to bring the print head into selective contact with the heat transfer member.

8. The inkjet printing apparatus according to claim 7, wherein the print head uses heat energy to eject the ink.

9. The inkjet printing apparatus according to claim 8, wherein the print head comprises a plurality of heating elements configured to expand the ink for ejection.

10. The inkjet printing apparatus according to claim 7, wherein the heat transfer member is formed of metal.

11. The inkjet printing apparatus according to claim 7, wherein a portion of the heat transfer member which comes into contact with the print medium is positioned downstream of the platen, and a portion of the heat transfer member which comes into contact with the print head is positioned opposite the print head.

12. The inkjet printing apparatus according to claim 11, wherein the print head is guided along a shaft so as to be movable in a direction crossing the conveying direction of the print medium.
